(19) United States
(12) Patent Application Publication
(10) Pub. No.: US 2026/0363422 A1
(43) Pub. Date: Nov. 19, 2026

(54) WAIST BELT

(71) Applicant: SAFEHOLD LIMITED, Canterbury (GB)

(72) Inventor: Oliver AUSTON, Canterbury (GB)

(73) Assignee: SAFEHOLD LIMITED, Canterbury (GB)

(21) Appl. No.: 19/470,971

(22) PCT Filed: Mar. 28, 2024
(86) PCT No.: PCT/GB2024/050890

§ 371 Date: Sep. 30, 2025

(30) Foreign Application Priority Data
Mar. 30, 2023 (GB) 2304729.3

(51) Int. Cl. A45F 5/02; A45F 3/14; A62B 35/00

(52) U.S. Cl. CPC A45F 5/021; A45F 2003/144; A62B 35/0025

(57) ABSTRACT

A waist belt comprising an elongate strap of material; wherein the strap includes a first part of a two-part coupling at one end thereof, and a second part of the two-part coupling at the opposite end thereof; the strap defines a longitudinal axis; the waist belt includes at least one rail member which is carried by the strap; and wherein the waist belt further includes one or more connectors which are slidably coupled to the rail member or one of the rail members.

The subject invention relates to a waist belt or tool belt and, in particular, to a waist belt which is capable of holding a plurality of tools, equipment and/or accessories.

People working at height, or indeed in a range of activities, need to tether off or secure equipment, this includes but is not limited to: hand tools, bolt bags, carabiners, climbing accessories and the like. Currently this can be done via one or more fixed loops or dedicated connections which may be provided on a user's waist belt. However, as users/workers are individuals, the position of the fixed loops and/or dedicated connections may not be convenient. Additionally, for users/workers who are working at height or wearing some form of chest harness, there are other straps connecting the waist belt to a safety harness, which results in the waist belt becoming a cluttered and restricted area.

In the context of the present invention, the terms “waist belt” and “tool belt” are used interchangeably, as the waist belt of the present invention is suitably worn around the waist of a user and may carry one or more tools or other equipment.

It is therefore desired to provide a more flexible waist belt.

According to a first aspect of the invention, there is provided a waist belt comprising an elongate strap of material; wherein the strap includes a first part of a two-part coupling at one end thereof, and a second part of the two-part coupling at the opposite end thereof; the strap defines a longitudinal axis; the waist belt includes at least one rail member which is carried by the strap; wherein the at least one rail member is fixed to the strap; and wherein the waist belt further includes one or more connectors which are slidably coupled to the rail member or one of the rail members.

Thus, the invention provides a waist belt wherein the opposed ends of the strap may be coupled together to form a loop is use. The rail member(s) and associated connector(s) form one or more flexible storage points which may be displaced relative to (i.e., along) the or each rail member such that they are located in a position that is convenient for the user. Tools or other equipment needed by the user may then be secured to the or a respective one of the connectors.

In the context of the present invention, the term “fixed to the strap” means that the or each rail member is not detachable from the strap. Thus, the strap and the or each rail member are arranged together as a single component.

The two-part coupling may be a detachable or releasable two-part coupling.

In an embodiment of the invention, the rail member is arranged to be parallel to the longitudinal axis.

Suitably, the rail member extends from a point adjacent to the first part of the two-part coupling to a point adjacent to the second part of the two-part coupling. Thus, the rail member may extend along substantially the entire length of the strap. This provides the maximum length of the rail member, which in turn provides the maximum flexibility for the waist belt in terms of locations at which tools or other equipment may be located or carried.

In an embodiment of the invention, the rail member is formed from a flexible material. In the context of the present invention, the term “flexible” means that the or each rail member is able to be deflected as the strap is deflected while substantially maintaining its cross-sectional shape. For example, the or each rail member may be formed from a deflectable polymeric material, wherein the rail member may be bent or deflected while substantially maintaining its cross-sectional shape. Thus, it may be deflected without significant deformation.

The or each connector may include a rail coupling portion via which the connector is slidably coupled to the respective rail member, and a tool connecting portion via which a tool or other piece of equipment may be coupled to the waist belt. For example, the connecting portion of the connector may be formed by a loop, a hook or a carabiner. Additionally or alternatively, the connecting portion may comprise one part of a two-part coupling arrangement, such as, for example, one part of a two-part snap-fit connector.

The waist belt of the invention suitably includes a plurality of connectors.

Additionally or alternatively, the waist belt may include a container which is slidably coupled to the or one of the rail members via one or more connectors. In such embodiments, the connector(s) for the container may form part of the container or are carried by the container such that the connector(s) are fixed relative to the container. Such containers may be used to carry loose items, such as fixings (screws, nuts, bolts, rivets, etc.). The container may include a closable lid or cover portion. The lid or cover portion may be latched in a closed configuration to prevent accidental egress of items carried within the container. The container may include two connectors.

In a further embodiment of the invention, the strap carries two or more rail members. In such embodiments, each rail member may be as defined and described hereinabove.

Suitably, the two or more rail members are arranged to be parallel to the longitudinal axis defined by the strap. Thus, the rail members may be parallel to each other. Providing two or more parallel rail members permits connectors to be slidably coupled to at least two rail members. This in turn provides a more secure coupling for the respective connectors. Accordingly, such connectors may be used to secure heavier tools or equipment to the waist belt.

The rail member(s) may have any cross-sectional shape that permits connectors to be slidably coupled thereto. For example, the or each rail member may have a circular, I-shaped or T-shaped cross-section. The or each connector therefore may define a correspondingly shaped rail coupling portion.

Thus, in embodiments in which the or each rail member has a circular cross-section, the rail coupling portion of the connectors may be C-shaped. In such embodiments, the rail coupling portion of the connector may form a snap fit with the rail member that permits displacement of the connector longitudinally along the rail member, but which prevents transverse displacement of the connector away from the rail member.

In embodiments in which the rail member has a circular cross-section, it may be formed from a solid cylindrical body or it may be formed from a hollow tubular body.

In a yet further embodiment of the invention, the or each rail member may be secured to the strap via a web of material. For example, the web of material may have a rail portion which overlies the rail member and one or more flap portions which extend from at least one side of the rail portion. In such embodiments, the flap portion(s) of the web of material may be secured to the strap of the waist belt, for example via stitching and/or an adhesive. The web of material may be a web of woven material, e.g., a woven fabric material, which is capable of securing the rail or each member to the strap without negatively impacting the ability of the rail member to be deflected in use.

Alternatively, the web of material may define one or more channels within which a respective rail member is disposed. The web of material may then be secured to the strap of the waist belt as discussed above (e.g., stitched and/or adhered to the strap). Again, the web of material may be a woven material.

The skilled person will appreciate that the waist belt may be secured to a safety harness. Typically, waist belts have been integrally formed with other safety harness straps (e.g., chest straps and the like). Thus conventional waist belts for workers working at height have not been interchangeable with different harness components. Thus, different combinations of harnesses and associated waist belts have been provided. However, in an embodiment of the present invention, the waist belt includes one or more harness connectors slidably coupled to the or each rail member, wherein the or each harness connector defines a channel through which a portion of a harness may be located. In this way, the waist belt of the invention may be used with different harness components. Therefore, only a single waist belt needs to be provided, which can be combined with the desired harness arrangement and configured for a user's needs.

Suitably, the channel defined by the or each harness connector includes a slot which defines an opening into the channel. In this way, a portion of a harness component may be located within the channel via the slot.

According to a second aspect of the invention, there is provided a combination of a safety harness and a waist belt according to the first aspect of the invention as defined herein, wherein the waist belt includes one or more harness connectors slidably coupled to the or each rail member; and wherein a strap of the safety harness is coupled to the or a respective one of the harness connectors carried by the waist belt. The harness connector may be as defined anywhere herein.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

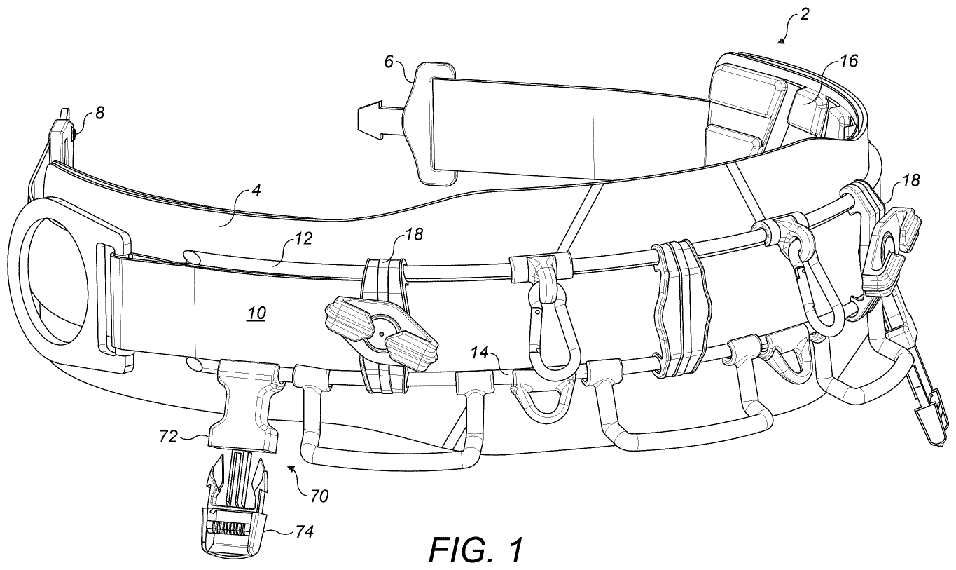

FIG. 1 shows a perspective view of a waist belt according to the invention;

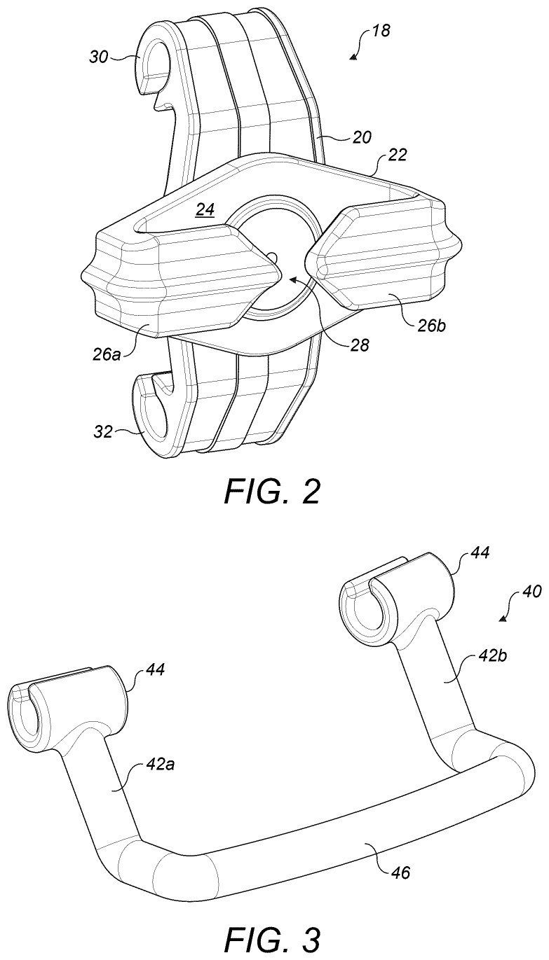

FIG. 2 shows a perspective view of a harness connector which may form part of the waist belt shown in FIG. 1;

FIG. 3 shows a perspective view of a first embodiment of a connector which may form part of the waist belt shown in FIG. 1;

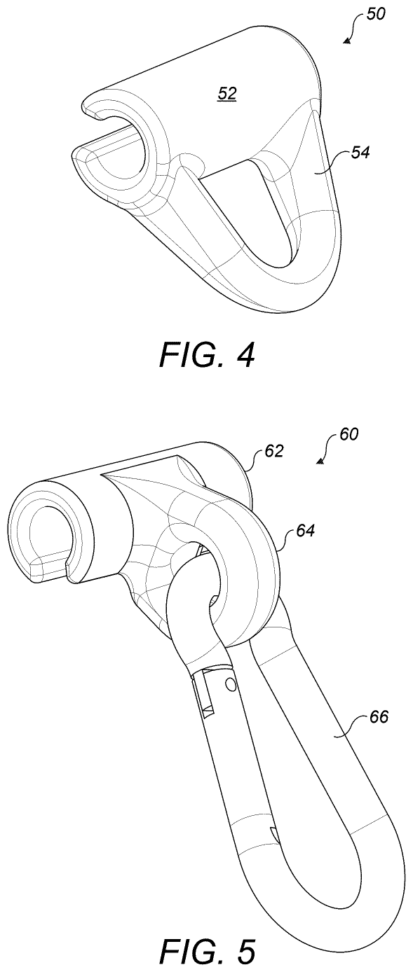

FIG. 4 shows a perspective view of a second embodiment of a connector which may form part of the waist belt shown in FIG. 1; and

FIG. 5 shows a perspective view of a third embodiment of a connector which may form part of the waist belt shown in FIG. 1.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a waist belt 2 according to the invention. The waist belt 2 includes a strap 4 which carries at a first end thereof a first part 6 of a releasable two-part coupling, and at a second, opposite end thereof a second part 8 of the releasable two-part coupling. The releasable two-part coupling may be any known releasable two-part coupling.

A rail member arrangement comprising a woven fabric web 10, an upper rail member 12 and a lower rail member 14 is stitched to the strap 4. The woven fabric web 10 defines an upper pocket into which the upper rail member 12 is disposed, and a lower pocket into which the lower rail member 14 is disposed.

Both the upper rail member 12 and the lower rail member 14 have a solid cylindrical body formed from a flexible polymeric material which deflects as the strap 4 is moved, but which does not deform or significantly change its cross-sectional shape when deflected.

A foamed polymeric cushion layer 16 is provided on the inwardly facing surface of the strap 4 (i.e., the surface of the strap 4 that contacts the torso of a user in use).

The upper and lower pockets of the woven fabric web 10 are arranged such that the upper rail member 12 and the lower rail member 14 are parallel to each other and the longitudinal axis defined by the strap 4.

Connected to both the upper rail member 12 and the lower rail member 14 are two harness connectors 18, one of which is shown in more detail in FIG. 2.

Each harness connector 18 includes a main body portion 20 and a harness channel defining element 22. The harness channel defining element 22 is rotationally coupled to the main body portion 20 such that the harness channel defining element 22 may rotate relative to the main body portion 20 between detent orientations defined by a circular array of teeth carried by the main body portion 20 and one or more corresponding teeth carried by the harness channel defining element 22. Such a rotational coupling is well known in the art and need not be described in more detail herein.

The harness channel defining element 22 includes a rear wall 24 and a pair of arms 26a, 26b which extend from the respective sides of the rear wall 24 and fold around to overlie portions of the rear wall 24 to define a channel between the rear wall 24 and the opposed arms 26a, 26b.

A slot 28 is defined between the opposed arms 26a, 26b which provides an opening into the channel.

The rotatable coupling between the main body portion 20 and the harness channel defining element 22 permits the orientation of the channel to be varied to match the orientation of the respective portion of a harness (not shown) that may be secured within the channel.

The main body portion 20 defines an upper snap fit coupling portion 30 and a lower snap fit coupling portion 32. Each of the upper and lower snap fit coupling portions 30, 32 are defined by C-shaped portions of the main body portion 20.

The spacing between the upper snap fit coupling portion 30 and the lower snap fit coupling portion is substantially identical to the spacing between the upper rail member 12 and the lower rail member 14. In this way, the upper snap fit coupling portion 30 forms a snap fit coupling with the upper rail member 12 and the lower snap fit coupling portion 32 forms a snap fit coupling with the lower rail member 14.

The snap fit couplings permit each harness connector 18 to move longitudinally along the upper and lower rail members 12, 14, but prevent lateral displacement of the harness connector 18 away from the upper and lower rail members 12, 14.

FIG. 3 shows a first embodiment 40 of a connector. The connector 40 includes a pair of spaced apart legs 42a, 42b. At a first end of each leg 42a, 42b is a C-shaped coupling element 44, similar to that described above. At the opposite end of each leg 42a, 42b is a crossbar 46 which connects the two legs 42a, 42b. The legs 42a, 42b are angled such that when an upper part of the legs 42a, 42b lie adjacent to the strap 4, the crossbar 46 is spaced from the strap 4 and defines a gap therebetween.

FIG. 4 shows a second embodiment 50 of a connector. The connector 50 includes a coupling body 52 which has a C-shaped cross-section. A tool body 54 extends from each end of the coupling body 52 and forms a continuous loop with the coupling body 52.

FIG. 5 shows a third embodiment 60 of a connector. The connector 60 includes a coupling body 62, which is similar to the coupling body 52, and which has a C-shaped cross-section. In this embodiment, a tool body 64 extends from a central portion of the coupling body 62, and the coupling body 62 defines therethrough an aperture. A carabiner 66 passes through the aperture and is coupled to the tool body 64. The carabiner 66 may be any type of known carabiner.

A fourth embodiment 70 of a connector is also shown in FIG. 1. The connector 70 is a snap-fit bayonet connector which comprises a receiver 72 and a bayonet component 74 which includes a pair of resiliently deformable legs, wherein each leg includes a distal lug. Such connectors are well known in the art. As shown in FIG. 1, the receiver 72 defines an elongate C-shaped coupling portion at one end and an opening to receive the bayonet component 74 at the opposite end. The skilled person will appreciate that the receiver 72 is coupled to a respective one of the rail members 12, 14 via the C-shaped coupling portion. A strap or other component may be connected to bayonet component 74 and this strap or other component may be connected to the waist belt 2 via the coupling between the bayonet component 74 and the receiver 72.

Each of the connectors 40, 50, 60 may be connected to a respective rail member 12, 14 via a snap-fit coupling between the C-shaped coupling element 44, 52, 62 and the respective rail member 12, 14.

The snap-fit coupling between the C-shaped coupling elements 30, 32, 44, 52, 62 permit the coupling element to slide longitudinally along the respective rail member 12, 14, but resist detachment of the C-shaped coupling element 30, 32, 44, 52, 62 from the rail member 12, 14. Accordingly, the harness connector(s) 18 and the tool connectors 40, 50, 60 may be positioned in the desired location along the respective rail member 12, 14.

1. A waist belt comprising an elongate strap of material; wherein the strap includes a first part of a two-part coupling at one end thereof, and a second part of the two-part coupling at the opposite end thereof; the strap defines a longitudinal axis; the waist belt includes at least one rail member which is carried by the strap; wherein the at least one rail member is fixed to the strap; and wherein the waist belt further includes one or more connectors which are slidably coupled to the rail member or one of the rail members.

2. A waist belt according to claim 1, wherein the rail member is arranged to be parallel to the longitudinal axis.

3. A waist belt according to claim 1, wherein the rail member is formed from a flexible material.

4. A waist belt according to claim 1, wherein the or each connector includes a rail coupling portion via which the connector is slidably coupled to the respective rail member, and a tool connecting portion via which a tool may be coupled to the waist belt.

5. A waist belt according to claim 4, wherein the connecting portion of the connector is formed by a loop, a hook or a carabiner.

6. A waist belt according to claims 1, wherein the waist belt includes a container which is slidably coupled to the or one of the rail members via one or more connectors.

7. A waist belt according to claim 1, wherein the strap carries two or more rail members.

8. A waist belt according to claim 7, wherein the rail members are arranged to be parallel to the longitudinal axis.

9. A waist belt according to claim 7, wherein at least one connector is slidably coupled to two of the rail members.

10. A waist belt according to claim 1, wherein the or each rail member is formed from a flexible polymeric material.

11. A waist belt according to claim 10, wherein the or each rail member has or includes a portion having a circular, I-shaped or T-shaped cross-section.

12. A waist belt according to claim 10, wherein the or each rail member is secured to the strap via a web of fabric material.

13. A waist belt according to claim 12, wherein the web of fabric material is stitched to the strap.

14. A waist belt according to claim 1, wherein the waist belt includes one or more harness connectors slidably coupled to the or each rail member, wherein the or each harness connector defines a channel through which a portion of a harness may be located.

15. A waist belt according to claim 14, wherein the channel defined by the or each harness connector includes a slot though which defines an opening into the channel.

16. A combination of a safety harness and a waist belt as defined in claim 14, wherein a strap of the safety harness is coupled to a respective harness connector carried by the waist belt.
